(19) United States
(12) Patent Application Publication
(10) Pub. No.: US 2007/0250847 A1
(43) Pub. Date: Oct. 25, 2007

(54) Movie Trailer Incentive System

(76) Inventor: Aric Gastwirth, Oak Park, CA (US)

Correspondence Address: PROSKAUER ROSE LLP, ONE INTERNATIONAL PLACE, BOSTON, MA, 02110, US

(21) Appl. No.: 11/622,557

(22) Filed: Jan. 12, 2007

Related U.S. Application Data
(60) Provisional application No. 60/745,104, filed on Apr. 19, 2006.

(51) Int. Cl. H04N 9/00

(52) U.S. Cl. 725/13

(57) ABSTRACT

A system and method are provided for delivering a promotional message to an audience via a movie/film trailer. The system and method include combining a promotional message with a movie/film trailer, providing the combined movie/film trailer to an audience, and soliciting a response to the promotional message from members of the audience, the response being communicated through a text-message enabled device. The text-message enabled device can be a cell phone. The system and method further include formatting the combined movie/film trailer to be displayed on a cinematic screen, an analog display device, or a digital display device.

### RELATED APPLICATION

This application claims the benefit of U.S. Provisional Application No. 60/745,104, filed on Apr. 19, 2006 the entire teachings of which are incorporated herein by reference.

### BACKGROUND

Movies that are scheduled to be released are typically advertised in advance via movie/film trailers. A movie/film trailer is an assembly of short clips and/or sound bites from the movie and is shown preceding the start of a presently showing feature film, as a television commercial, or a downloadable medium via the internet. As a promotional vehicle, movie trailers are fashioned to generate interest in the viewing audience about the pending release of the subject movie.

### SUMMARY

These movie/film trailers provide no means for determining how the movies in which the movie/film trailer reached members of the viewing audience. Accordingly, a need exists to provide additional promotional material through the movie/film trailers to solicit a response from the viewing audience.

A system and method are provided for delivering a promotional message to an audience via a movie/film trailer. The method includes combining a promotional message with a movie/film trailer, providing the combined movie/film trailer to an audience, and soliciting a response to the promotional message from members of the audience, the response being communicated through a text-message enabled device. The text-message enabled device can be a cell phone, personal digital assistant (PDA), or computer. The method further includes formatting the combined movie/film trailer to be displayed on a cinematic screen, an analog display device, or a digital display device.

The promotional message can be integrated with the movie/film trailer. The promotional message can be a visual message, an audio message, or an audiovisual message. The promotional message can include a numeric code and alphanumeric keyword. The numeric code can be representative of a short-message-service code. The alphanumeric keyword can be representative of the promotional message.

The method further includes transmitting the numeric code and alphanumeric keyword to a host module via the text-message enabled device. The host module includes a program manager module for managing the promotional messages.

The system and method provide the advantages of being able to add additional promotional material to an existing promotional medium (e.g. a movie/film trailer) to increase audience response. Further, the promotional material can utilize short-message-service (SMS) code as a revenue stream thereby reducing advertising and solicitation costs.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1A is an illustration for delivering a promotional message to an audience via a movie/film trailer on a cinematic screen;

FIG. 1B is an illustration for delivering a promotional message to an audience via a movie/film trailer on a computer display;

FIG. 1C is an illustration for delivering a promotional message to an audience via a movie/film trailer on a television display/monitor;

FIG. 1D is an illustration for delivering a promotional message to an audience via a movie/film trailer on a cell phone display; and

FIG. 2 is a module based diagram of the system described in FIGS. 1A-1D.

### DETAILED DESCRIPTION

Generally, movie/film trailers or teasers are film advertisements for films to be exhibited in the future at a cinema, on whose screen they are shown; they are commonly known as previews of coming attractions. Trailers normally consist of a series of selected shots from the film being advertised. Since the purpose of the trailer is to attract an audience to the film, these excerpts are usually drawn from the most exciting, funny, or otherwise noteworthy parts of the film but in abbreviated form and without producing spoilers. Additional promotional material/message can be combined or added with these movie/film trailers to increase audience response, participation, and attraction.

The promotional message is typically a contest used to solicit a response from members of the audience. For example, the participating movie patron may enter to win a chance for a day on the set of the shoot (if still in production, or a sequel, if applicable), a chance to be in the movie being advertised (or its sequel), or a chance to attend the world premier, or even win a cash prize. The response is communicated via a text-message enabled device in the form of a short message or “text message” through a short message service commonly referred to as SMS messaging. The “text messages” are often used to interact with automated systems or a program manager to manage the contest. The “text message” is typically a premium-type “text message.” A premium-type text message has a fee associated with the contest by the cell phone service provider. Presently, cell phone service providers charge the cell phone user (member of the audience) fees ranging from $0.99 to $9.99 per premium-type “text message.” The cellular phone service provider provides the surplus funds collected to the promotion manager or campaign organizer. The promotion manager or campaign organizer in turn provides a portion of these revenues generated from the premium-type “text messages” to the movie distributor participating in the campaign and/or promotion associated with the specific movie/film trailers. The revenues generated from the “text messages” help reduce the overall advertising cost associated with the movie/film trailers, while the promotional message itself gets members of the audience further interested in the movie/film trailers.

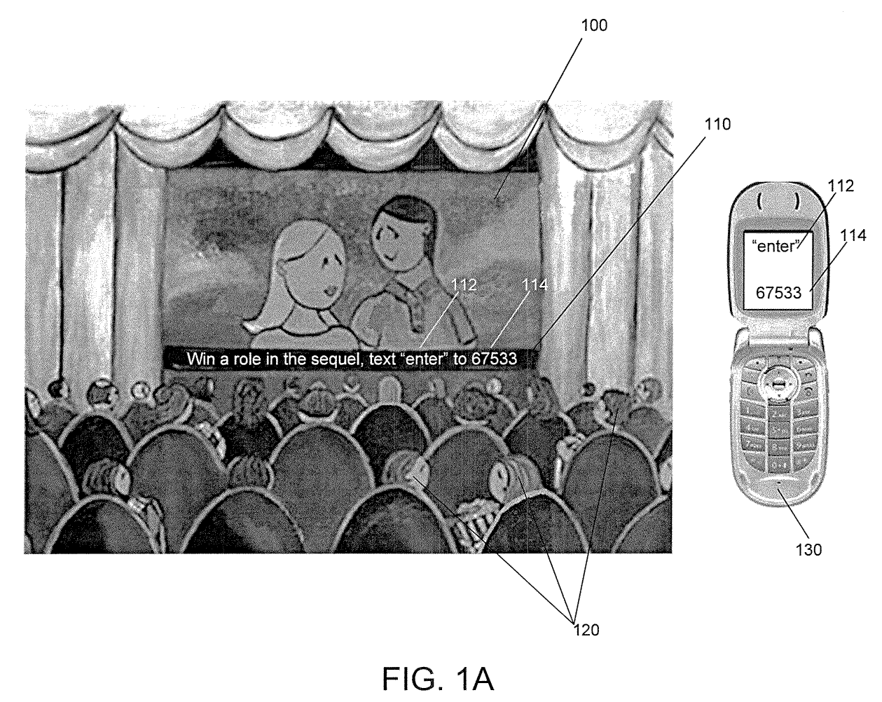

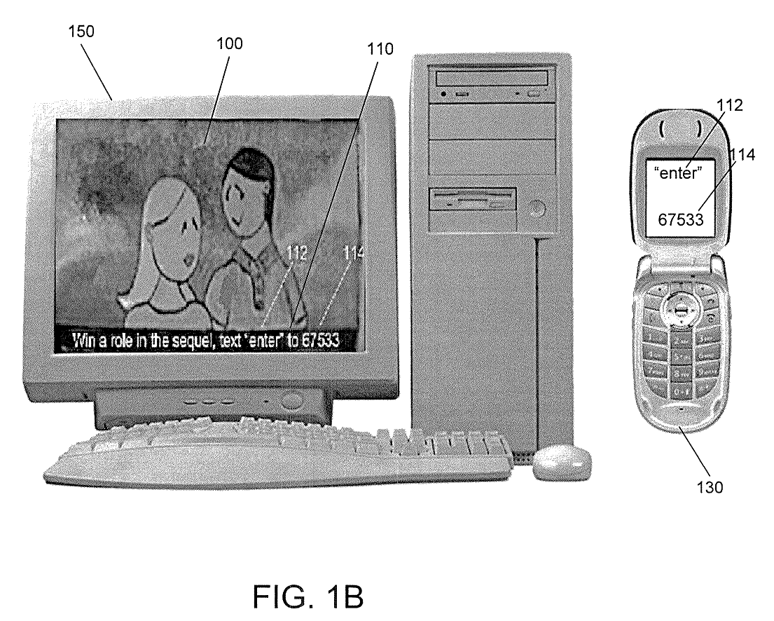

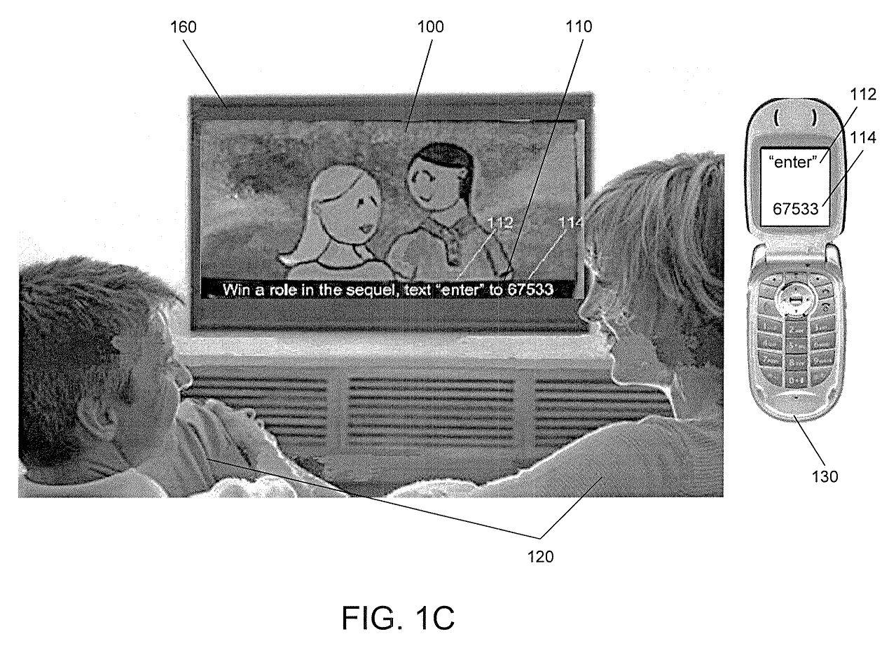

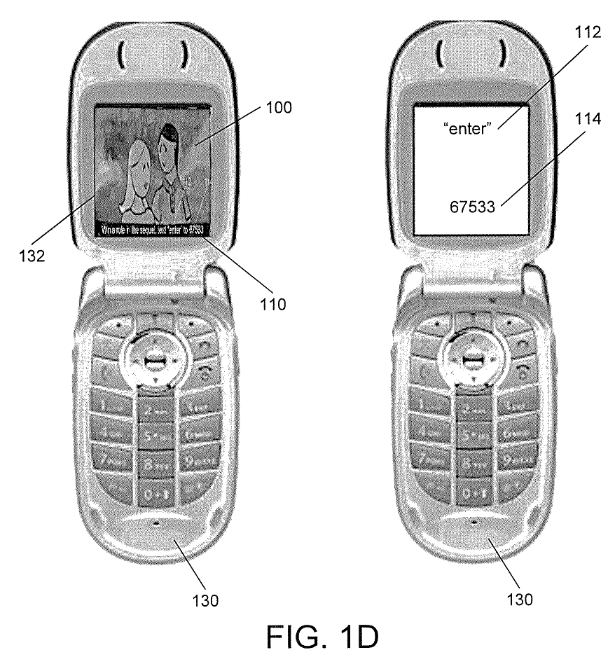

FIG. 1A-1D illustrate a variety of viewing media used to display movie/film trailers to an audience. For example, FIG. 1A shows a movie/film trailer 100 with combined promotional information 110 displayed to an audience 120 in a cinematic screen format. As shown, the promotional message 110 is a contest to win a role in the sequel to the movie/film trailer 100 and is combined with (i.e., in close relation with) the movie/film trailer 100. The promotional message 110 includes an alphanumeric keyword 112 and a numeric code 114 associated with the contest. The alphanumeric keyword 112 is representative of the promotional message 110 and the numeric code 114 is representative of the short-message-service code. The promotional message 110 solicits members of the audience 120 to respond via a text-message enabled device 130, such as a cell phone. As such, the member of the audience 120 need only send a premium-type “text message” to a number associated with the contest. For the example, a member of the audience 120 can respond by sending the text message “enter” 112 to the number “67533” 114 associated with the contest.

FIG. 1B shows a movie/film trailer 100 with combined promotional information 110 displayed to a user in an analog or digital format on a computer screen 150. As shown, the promotional message 110 is a contest to win a role in the sequel to the movie/film trailer 100 and is combined with the movie/film trailer 100. The promotional message 110 includes an alphanumeric keyword 112 and a numeric code 114 associated with the contest. The alphanumeric keyword 112 is representative of the promotional message 110 and the numeric code 114 is representative of the short-message-service code. The promotional message 110 solicits a viewer/user to respond via a text-message enabled device 130, such as a cell phone. As such, the viewer/user need only send a premium-type “text message” to a number associated with the contest. For the example, the viewer/user can respond by sending the text message “enter” 112 to the number “67533” 114 associated with the contest.

FIG. 1C shows a movie/film trailer 100 with combined promotional information 110 displayed to an audience 120 in an analog or digital format on a television screen/monitor 160. As shown, the promotional message 110 is a contest to win a role in the sequel to the movie/film trailer 100 and is combined with the movie/film trailer 100. The promotional message 110 includes an alphanumeric keyword 112 and a numeric code 114 associated with the contest. The alphanumeric keyword 112 is representative of the promotional message 110 and the numeric code 114 is representative of the short-message-service code. The promotional message 110 solicits members of the audience 120 to respond via a text-message enabled device 130, such as a cell phone. As such, the member of the audience 120 need only send a premium-type “text message” to a number associated with the contest. For the example, a member of the audience 120 can respond by sending the text message “enter” 112 to the number “67533” 114 associated with the contest.

FIG. 1D shows a movie/film trailer 100 with combined promotional information 110 displayed to a user in an analog or digital format on a cell phone display 132. As shown, the promotional message 110 is a contest to win a role in the sequel to the movie/film trailer 100 and is combined with the movie/film trailer 100. The promotional message 110 includes an alphanumeric keyword 112 and a numeric code 114 associated with the contest. The alphanumeric keyword 112 is representative of the promotional message 110 and the numeric code 114 is representative of the short-message-service code. The promotional message 110 solicits the cell phone viewer to respond via a text-message enabled a cell phone 130. As such, the cell phone viewer need only send a premium-type “text message” to a number associated with the contest. For the example, cell phone viewer can respond by sending the text message “enter” 112 to the number “67533” 114 associated with the contest.

It should be understood the promotional message 110 can be a visual message, an audio message, and/or an audiovisual message. Further, it should be understood that the promotional message 110 can be seamlessly combined anywhere in or around the movie/film trailer 100. For example, the promotional message 110 can be formatted to frame the movie/film trailer 100.

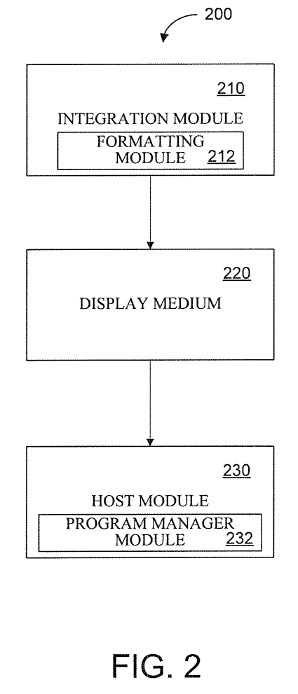

FIG. 2 is a system diagram 200 for delivering a promotional message to an audience via a movie/film trailer or teaser. The system 200 includes an integration module 210, a display medium 220, and a host module 230.

The integration module 210 combines the promotional message with the movie/film trailer or teaser. In some embodiments, the intergration module 210 is a computer program running on a processor that allows a user to create the promotional message and seamlessly integrate the promotional message with the movie/film trailer. Further, the integration module can establish a code and keyword that may be used both to direct and correlate the anticipated inputs of the members of the audience. The promotional message can be a visual message, an audio message, and/or an audiovisual message. The integration module 210 includes a formatting module 212 for formatting the combined movie/film trailer to be displayed on a cinematic screen, an analog display device, or a digital display device.

The display medium 220 displays the combined movie/film trailer to an audience. The display medium 220 includes any human readable format of display or audio presentation that may support both a movie/film trailer (and/or movie teaser) and promotion notice field that may include an audio notice segment. The display medium 220 can be a cinematic display, an analog display, and/or and digital display. For example, the display medium 220 can be a cinematic screen, a computer display/monitor, a television display/monitor, a cell phone display, and/or a PDA.

The host module 230 receives and compiles the solicited response to the promotional message from members of the audience. The host module 230 includes a program manager module 232 for managing the promotion messages received by the host module. In some embodiments, the host module 230 and program manager 232 is a computer program running on a processor that can determine the amount of revenue generated by the promotional message and further determine the contest winner.

In some embodiments, the host module 230 and program manager 232 are in communication with a communication service provider and a content provider. The host module 230 and program manager 232 communicate collaborate with the content provider to establish one or more incentive prizes that may be included with the promotion. The communication service provider collects revenue via the premium-type “text messages” and provides revenue from the participating cellular users and may provide the participant entry information directly to the content provider or indirectly to the content provider via the host module 230 and program manager 232. The host module 230 and program manager 232 provides a portion of the revenue received from the communication service provider as participation revenue to the associated content provider. The host module 230 and program manager 232 and content provider may process the entry information and determine the incentives to be distributed as incentive prizes to one or more of the members of the participant group.

It should be understood that a the movie trailer or teaser and/or promotional message may play in a visual or audiovisual format theatrically, via a DVD or VHS recording, a downloadable computer multimedia file, via streaming computer video or other medium by which a movie trailer or teaser may play. Similarly, movie audio teasers and/or audio promotional messages may play in an audio format theatrically, via a DVD or VHS recording, a downloadable computer audio file, via streaming computer audio files or other medium by which a movie audio teaser may play.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for delivering a promotional message to an audience via a movie/film trailer, comprising:
combining a promotional message with a movie/film trailer;
providing the combined movie/film trailer to an audience; and
soliciting a response to the promotional message from members of the audience, the response being communicated through a text-message enabled device.

2. The method of claim 1, further comprising formatting the combined movie/film trailer to be displayed on a cinematic screen, an analog display device, or a digital display device.

3. The method of claim 1, wherein the promotional message is seamlessly integrated with the movie/film trailer.

4. The method of claim 1, wherein the promotional message is a visual message, an audio message, or an audiovisual message.

5. The method of claim 1, wherein the promotional message includes a numeric code and alphanumeric keyword.

6. The method of claim 5, wherein the numeric code is a short-message-service code.

7. The method of claim 5, wherein the alphanumeric keyword is associated with the promotional message.

8. The method of claim 5, further comprising transmitting the numeric code and alphanumeric keyword to a host module via the text-message enabled device.

9. The method of claim 8, wherein the host module includes a program manager module for managing the promotional messages.

10. The method of claim 1, wherein the text-message enabled device is a cell phone, a computer, a text messaging pager, and a personal digital assistant.

11. A system for delivering a promotional message to an audience via a movie/film trailer, comprising:
an integration module for combining a promotional message with a movie/film trailer;
a display medium for displaying the combined movie/film trailer to an audience; and
a host module for receiving a solicited response to the promotional message from members of the audience, the response being communicated through a text-message enabled device.

12. The system of claim 11, further comprising formatting module for formatting the combined movie/film trailer to be displayed on a cinematic screen, an analog display device, or a digital display device.

13. The system of claim 11, wherein the promotional message is integrated with the movie/film trailer.

14. The system of claim 11, wherein the promotional message is a visual message, an audio message, or an audiovisual message.

15. The system of claim 11, wherein the promotional message includes a numeric code and alphanumeric keyword.

16. The system of claim 15, wherein the numeric code is a short-message-service code.

17. The system of claim 15, wherein the alphanumeric keyword is associated with the promotional message.

18. The system of claim 11, wherein the host module includes a program manager module for managing the promotional messages.

19. The system of claim 11, wherein the text-message enabled device is a cell phone, a computer, a text messaging pager, and a personal digital assistant.

20. A method for delivering a promotional message to an audience via a movie/film trailer, comprising:
means for combining a promotional message with a movie/film trailer;
means for providing the combined movie/film trailer to an audience; and
means for soliciting a response to the promotional message from members of the audience, the response being communicated through a text-message enabled device.
